(19) United States
(12) Patent Application Publication
(10) Pub. No.: US 2008/0139205 A1
(43) Pub. Date: Jun. 12, 2008

(54) METHOD AND APPARATUS FOR SUPPORTING HANDOVER IN A COMMUNICATION NETWORK

(75) Inventor: Shahab M. Sayeedi, Naperville, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/857,629

(22) Filed: Sep. 19, 2007

Related U.S. Application Data
(60) Provisional application No. 60/869,147, filed on Dec. 8, 2006.

(51) Int. Cl. H04M 1/66; H04Q 7/20

(52) U.S. Cl. 455/436; 455/411

(57) ABSTRACT

Various embodiments are described to better facilitate handover, particularly unsolicited handover, in communication networks. Generally, embodiments of the present invention allow for the ASNs (access service networks) (131 and 141) that may be selected for handover by a remote unit (101) to begin receiving information related to such a handover earlier than they would have using prior art techniques and possibly before a request for handover is received from the remote unit. When the serving ASN (121) detects a communication loss with the remote unit, it proceeds to either provide handover-related information for the remote unit to the potential target ASNs or to initiate the transfer of this information. Thus, latency delay may be reduced by various embodiments of the present invention, if this handover-related information can be provided to the target ASN more quickly.

### REFERENCE(S) TO RELATED APPLICATION(S)

The present application claims priority from a provisional application, Ser. No. 60/869,147, entitled “METHOD AND APPARATUS FOR SUPPORTING HANDOVER IN A COMMUNICATION NETWORK,” filed Dec. 8, 2006, which is commonly owned and incorporated herein by reference in its entirety.

### FIELD OF THE INVENTION

The present invention relates generally to communication systems and, in particular, to supporting handover in communication networks.

### BACKGROUND OF THE INVENTION

An unsolicited handover occurs when an 802.16e-based mobile initiates a handover by performing handover ranging at a target base station (BS), which has not been previously notified of an impending handover by the MS's serving BS. An unsolicited inter-ASN handover occurs when a mobile station (MS) begins handover ranging at a target BS controlled by a target access service network (ASN), which is different than its current serving ASN, and when the target BS/ASN has not been notified of an impending handover by the MS's serving ASN. When an unsolicited handover occurs, the target BS/ASN does not have context information for the MS. Context information for the MS may include an Authenticator context or an Authenticator ASN ID (which indicates where the authenticator context may be retrieved from), the Anchor DP ASN ID for the ASN that hosts the MIP (mobile internet protocol) foreign agent and data path function for the MS, and the latest MAC (media access control) information for the MS. Unsolicited handovers result in latency delays and, in the worst case, may cause the failure of real-time applications supported by the mobile prior to the handover.

An authenticator context for an MS includes, for example, a Security Association context and an Authentication Key (AK) context. A Security Association context includes, for example, a Security Association descriptor, traffic encryption key (TEK) parameters, Packet Number, etc., all of which are specified in 802.16e-2005. An Authenticator Key context includes Authentication Key information, AK SN, AK Lifetime, PMS SN, PMK2SN, etc., all which are also specified in 802.16e-2005.

When a handover of an 802.16e mobile is desired, the MS may notify its current serving BS or serving ASN, which controls the serving BS via its ASN-Gateway, that it intends to perform a handover. The serving ASN, in turn, can then notify the target ASN(s), controlling potential target BSs to which the MS may attempt to handover, via the backbone network in order to prepare the target ASN(s) for a handover of the MS. The target BS/ASN may then allow non-contention-based Initial Ranging opportunities and a dedicated bandwidth allocation for the MS to support handover ranging. However, when a target ASN fails to receive prior notification of an impending handover of an MS from the MS's current serving ASN, the handover that occurs is treated as an unsolicited handover.

A serving ASN may fail to notify a target ASN of an impending handover of an MS for many reasons. One reason may be that the serving BS/ASN itself may not have been notified by the mobile that it intended to handover to a particular target BS/ASN. IEEE 802.16e does not mandate that a mobile notify its current serving BS/ASN of its intention to handover to a target BS/ASN, and an MS may autonomously do so without the serving BS/ASN's knowledge. Hence, not all 802.16e/WiMAX (Worldwide Interoperability for Microwave Access) handset vendors may implement such MS-handover-notification functionality in their products.

Another reason a serving BS/ASN may fail to receive notification from the mobile that it intends to handover to a particular target BS/ASN is because a handover notification, sent by the mobile, may not have been received at the serving BS/ASN due to deteriorating wireless conditions over the air, resulting in either the handover notification sent by the MS (802.16e MOB_MSHO-REQ message) being lost over the air or the message not being sent at all. For example, the message may not be sent because the mobile is attempting to expedite the handover to a target BS/ASN with better radio conditions before its call gets dropped. Deteriorating radio conditions over the air is a common occurrence in wireless networks.

A target BS/ASN may also fail to receive prior notification of an impending handover from an MS's current serving BS/ASN when an MS notifies the serving BS/ASN of its intent to handover to one of a set of potential target BSs by sending the MOB_MSHO-REQ message to the serving BS/ASN, which in turn notifies all the potential target BS/ASNs before the handover takes place and confirms a target BS, but the mobile decides at the time of the handover to handover to a different target BS/ASN that was not notified of the impending handover. See e.g., 802.16e-2005 6.3.22.2 HO process and 6.3.22.2.2 HO decision and initiation. This scenario can also occur due to rapidly changing air interface conditions and is supported by the 802.16e standard.

Hence, unsolicited handovers will be a frequent occurrence in 802.16e-based networks such as WiMAX networks.

When a target ASN is notified by the serving ASN of an impending handover from an MS, the target BS/ASN provides bandwidth for the MS to complete handover ranging quickly. However if the target ASN is not informed of the impending handover, an MS initiating an unsolicited handover must range anonymously using a CDMA ranging code and may not receive enough bandwidth from the target BS to complete handover ranging or complete it fast enough. The mobile may need to resend the RNG-REQ message multiple times until all of the TLVs and more specifically for this invention, the Ranging Purpose Indication, which signals a handover, and the Serving BSID can be sent. See e.g., 802.16e-2005 6.3.10.3.3 CDMA handover ranging and automatic adjustment, 6.3.10.3.1 Contention-based initial ranging and automatic adjustments and 6.3.2.3.5 Ranging request (RNG-REQ) message. This means that an unsolicited handover may be delayed by several seconds until the RNG-REQ message and all of the required TLVS for handover are successfully transmitted and the RNG-REQ from the MS is authenticated.

A target BS/ASN can detect that an MS is initiating an unsolicited inter-ASN handover when it receives a RNG-REQ message from an MS. Since the target ASN was not previously notified by the serving ASN previously supporting the mobile of an impending handover from the MS, the target ASN will not have the context information it needs. The target ASN can then use the serving BSID information, if it is provided by the mobile in the RNG-REQ message, to obtain context information for the MS so that it can authenticate and setup data path connections for the mobile, before accepting the handover and admitting the mobile into the network. See e.g., 802.16e-2005 6.3.2.3.5 and 6.3.22.2. If a mobile doesn't provide the Serving BSID TLV in the 802.16e RNG-REQ message when it initiates the unsolicited handover at a target BS/ASN, a full network re-entry procedure and re-authentication will be required since the target ASN has no authenticator information for the MS.

At best, if handover ranging from a mobile is received for an unsolicited handover by a target BS/ASN, if bandwidth is available at the target BS/ASN and granted to the MS for completing handover ranging, and if the MS included the Serving BS-ID TLV in the RNG-REQ message when it initiated the unsolicited handover ranging, latency delays will result while the target ASN prepares for the handover by requesting Authenticator ID, Anchor ASN ID, and the latest MAC context for the MS from the serving ASN (presently requires two messages), by requesting Authenticator context and service authorization information for the MS from the Authenticator ASN to authenticate the MS and the RNG-REQ, and by initiating data path registration with the anchor ASN prior to accepting the handover.

In the worst case scenario, if handover ranging is delayed due to lack of bandwidth for anonymous ranging and/or the MS doesn't provide the Serving BS-ID TLV in the RNG-REQ message during handover ranging, an unsolicited handover can take several seconds to complete and can result in unacceptable handover performance, particularly for real-time services such as VoIP (voice over internet protocol). Handover latency delays can result in delay sensitive applications that may have been active prior to the handover at the Serving ASN to fail while full network re-entry and re-authentication occur.

The prior art (WiMAX Network Stage-3 v&v document section 5.7.2) offers the following solution, with reference to signaling flow 10 on FIG. 1, for supporting unsolicited handovers in a WiMAX network if the MS provides the Serving BSID information when it begins ranging at the Target ASN. After the MS arrives at the Target ASN and begins handover ranging (RNG_REQ message sent), target ASN uses the Serving BSID provided by the MS to contact the Serving ASN to request the ASN Authenticator ID and Anchor ASN ID in steps 1 and 2. The Target ASN uses the Authenticator ASN ID provided to contact the Authenticator ASN to obtain Authenticator context for the mobile (e.g., Security Association context and Authentication Keys context) in steps 4 and 5. The target ASN uses the Anchor DP ASN ID in steps 7-9 to establish data path connections with the Anchor DP ASN where the data path (DP) function is located. The MS is then allowed entry into the network after the handover.

If the MS doesn't provide the serving BSID when it initiates handover ranging at the target BS, prior art techniques utilize a full network re-entry including re-authentication. This can take several seconds depending on where and how busy the authenticator ASN is. For this and the various other reasons described above, it would be desirable to have a method and apparatus that could better support handover, particularly unsolicited handover, in communication networks.

### BRIEF DESCRIPTION OF THE DRAWINGS

FIG. 1 is a signaling flow diagram that depicts a method for supporting unsolicited handovers in a WiMAX network, in accordance with the prior art.

FIG. 2 is a block diagram depiction of a wireless communication system in accordance with multiple embodiments of the present invention.

FIG. 3 is a signaling flow diagram that depicts an example of a serving ASN pushing context information obtained from the authenticator ASN to potential target ASNs, in accordance with multiple embodiments of the present invention.

FIG. 4 is a signaling flow diagram that depicts an example of a serving ASN identifying the authenticator ASN from which context information may be obtained by a target ASN, in accordance with multiple embodiments of the present invention.

FIG. 5 is a signaling flow diagram that depicts an example of a serving ASN pushing context information to potential target ASNs, in accordance with multiple embodiments of the present invention.

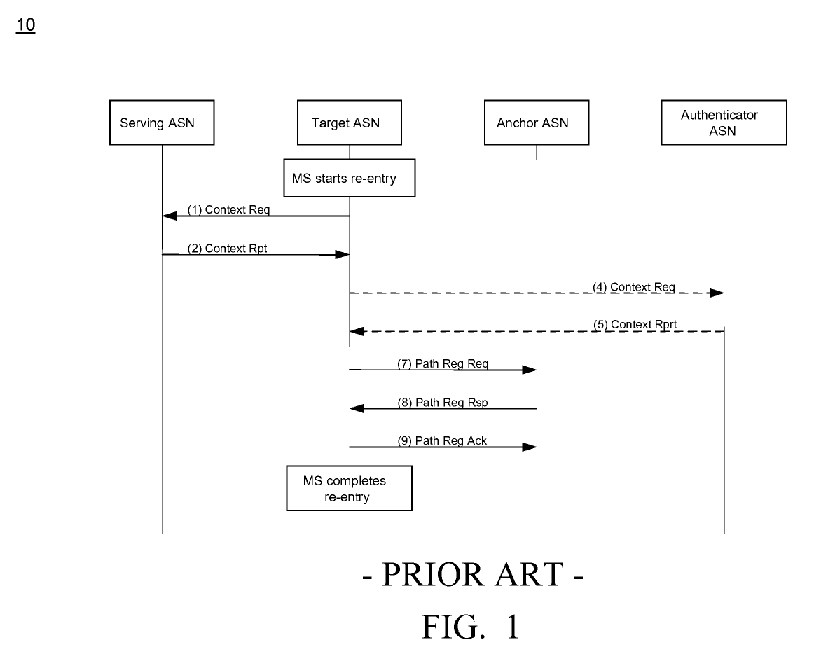

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams above are described and shown with reference to specific signaling exchanged in a specific order, some of the signaling may be omitted or some of the signaling may be combined, sub-divided, or reordered without departing from the scope of the claims. Thus, unless specifically indicated, the order and grouping of the signaling depicted is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to better facilitate handover, particularly unsolicited handover, in communication networks. Generally, embodiments of the present invention allow for the ASNs that may be selected for handover by a remote unit to begin receiving information related to such a handover before a request for handover is received from the remote unit. When the serving ASN detects a communication loss with the remote unit, it proceeds to either provide handover-related information for the remote unit to the potential target ASNs or to initiate the transfer of this information. Thus, latency delay may be reduced by various embodiments of the present invention, if this handover-related information can be provided to the target ASN more quickly.

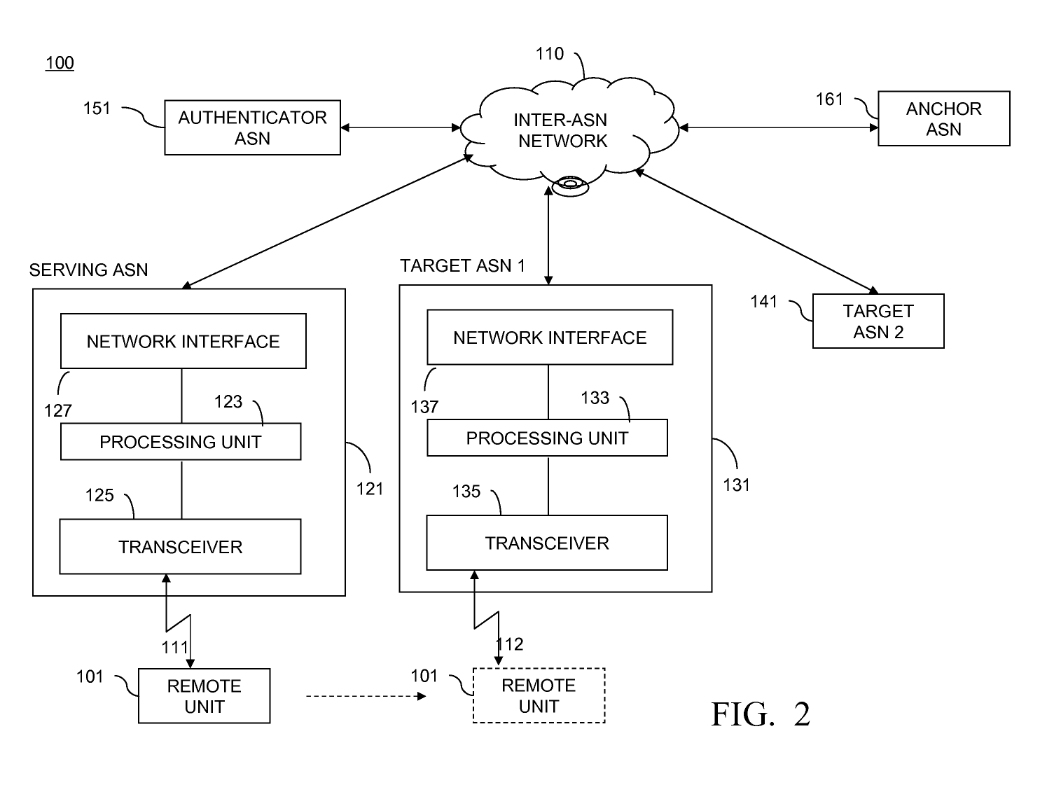

The disclosed embodiments can be more fully understood with reference to FIGS. 2-5. FIG. 2 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.orq/, http://www.3gpp2.com/, http://www.ieee802.orq/, and http://www.wimaxforum.org/ respectively.) Communication system 100 represents a system having an architecture in accordance with one or more of the WiMAX Forum and/or IEEE 802 technologies, suitably modified to implement the present invention. Alternative embodiments of the present invention may be implemented in communication systems that employ other or additional technologies such as, but not limited to, those described in the OMA, 3GPP, and/or 3GPP2 specifications.

Communication system 100 is depicted in a very generalized manner. In particular, access service network (ASN) 121 is shown communicating with remote unit 101 via wireless interface 111, this interface being in accordance with the particular access technology utilized by ASN 121, such as an IEEE 802.16-based wireless interface. In addition, target ASNs 131 and 141 are depicted as potential handover targets for remote unit 101. Should remote unit 101 select ASN 131 as its target for a handover, then remote unit 101 and ASN 131 would communicate via wireless interface 112, this interface being in accordance with the particular access technology utilized by ASN 131, such as an IEEE 802.16-based wireless interface. (In various places of this detailed description, reference is made to a remote unit selecting an ASN as its handover target. However, in many embodiments a remote unit actually selects a particular ASN component device, such as a base station (BS) for example. Therefore, references to selecting an ASN should be understood to include both selecting the ASN itself or selecting some part of the ASN.) Authenticator ASN 151 and anchor data path (DP) ASN 161 are also depicted, as well as inter-ASN network 110, through which the ASNs of system 100 communicate. Authenticator ASN 151 provides authentication services, while anchor DP ASN 161 provides an anchor DP function such as that described in the WiMAX Forum document entitled “WiMAX End-to-End Network Systems Architecture (Stage 3: Detailed Protocols and Procedures).” Although the authenticator ASN and the anchor DP ASN are different ASNs in system 100, a single ASN may serve as either or both authenticator and/or anchor DP. For example, serving ASN 121 could additionally perform the functions of authenticator and anchor DP in place of ASNs 151 and 161.

Those skilled in the art will recognize that FIG. 1 does not depict all of the physical fixed network components that may be necessary for system 100 to operate but only those system components and logical entities particularly relevant to the description of embodiments herein. For example, FIG. 1 depicts ASNs 121 and 131 as respectively comprising processing units 123 and 133, network interfaces 127 and 137, and transceivers 125 and 135. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, ASNs 121 and 131 represent known devices that have been adapted, in accordance with the description herein, to implement multiple embodiments of the present invention. Furthermore, those skilled in the art will recognize that aspects of the present invention may be implemented in and across various physical components and none are necessarily limited to single platform implementations. For example, processing unit 123, transceiver 125, and network interface 127 may be implemented in or across one or more network components, such as one or more base stations (BSs) and/or ASN gateways (ASN-GWs). Similarly, processing unit 133, transceiver 135, and network interface 137 may be implemented in or across one or more network components, such as one or more BSs and/or ASN-GWs.

Remote unit 101 and ASN 121 is shown communicating via a technology-dependent, wireless interface. Remote units, wireless devices, subscriber stations (SSs) or user equipment (UEs), may be thought of as mobile stations (MSs); however, wireless devices are not necessarily mobile nor able to move. In addition, remote unit platforms are known to refer to a wide variety of consumer electronic platforms such as, but not limited to, mobile stations (MSs), access terminals (ATs), terminal equipment, mobile devices, gaming devices, personal computers, and personal digital assistants (PDAs).

Operation of embodiments in accordance with the present invention occurs substantially as follows, first with reference to FIG. 2. ASN processing unit 123 detects, via transceiver 125, a communication loss with remote unit 101. Such a communication loss can have various causes, chief among these would simply be rapidly deteriorating air interface conditions. Anticipating that remote unit 101 may initiate an unsolicited handover with another ASN, serving ASN 121 proceeds to support or facilitate the handover in an attempt to reduce the handover delays that remote unit 101 will incur. Depending on the embodiment, serving ASN 121 may take various actions.

In some embodiments, in response to detecting the communication loss, ASN processing unit 123 sends to target ASNs 131 and 141, via network interface 127, authenticator context information and service authorization information for remote unit 101. This information is sent to ASNs 131 and 141 because they are determined to be potential handover targets, either of which (or any of which, if there are more than two potential target ASNs) remote unit 101 could select as its handover target. Depending on the embodiment, the authenticator context information that is sent may include one or more of the following: a Security Association descriptor, traffic encryption key (TEK) parameters, Packet Number, Authentication Key information, AK SN, AK Lifetime, PMS SN, and PMK2SN. Since this list is provided as an example for an 802.16-based system, further information regarding this information may be found in the 802.16e-2005 specification. Depending on the embodiment, the service authorization information that is sent may include information regarding the applicable user service level, such as QoS (quality of service) allowed, the number of service flows that can be supported, etc.

In addition to sending authenticator context information and service authorization information to the potential handover targets, the serving ASN may also send an authenticator ASN identifier, an anchor data path (DP) ASN identifier, MAC (media access control) context information for the remote unit, and/or an indication that the remote unit may initiate a handover with the target ASN. In general, the sooner a target ASN has information such as this for the remote unit, the less latency delay will result from the unsolicited handover.

For example, in the prior art, a target ASN would first receive a request for handover from the remote unit and then proceed to obtain context information from the authenticator ASN and to establish a data path by signaling with the anchor ASN. In contrast, embodiments of the present invention allow for the ASNs that may be selected for handover by the remote unit to begin receiving information related to such a handover before a request for handover is received from the remote unit. However, even if the remote has begun ranging with a target when the serving ASN detects that communication has been lost, the target can allocate dedicated bandwidth for handover ranging as a result of receiving the pushed handover information. When the serving ASN detects a communication loss with the remote unit, it begins to facilitate a handover by the remote unit with the potential target ASNs.

Depending on the embodiment, the serving ASN may take various actions. In some embodiments, in response to detecting the communication loss, ASN processing unit 123 via network interface 127 may request the authenticator context information and/or the service authorization information for the remote unit from authenticator ASN 151 by initiating a context request procedure. Upon receiving this information, ASN 121 can in turn send it to target ASNs 131 and 141, via network interface 127. Of course, in situations in which the serving ASN also happens to be the authenticator ASN a context request procedure is not necessary. The information can just be sent to target ASNs 131 and 141.

In other embodiments, serving ASN 121 may instead request authenticator ASN 151 to send the authenticator context information and/or the service authorization information for remote unit 101 to target ASNs 131 and 141 directly. Thus, ASN processing unit 123 via network interface 127 may send ASN identifiers, which identify target ASNs 131 and 141, to authenticator ASN 151 in response to detecting the communication loss. In this way, the ASNs that may be selected for handover by remote unit 101 can begin receiving information related to such a handover before a request for handover is received from remote unit 101.

In still other embodiments, serving ASN 121 may instead send target ASNs 131 and 141 an authenticator ASN identifier (which identifies ASN 151) and/or an anchor data path (DP) ASN identifier (which identifies ASN 161), in response to detecting the communication loss. Target ASNs 131 and 141 may then proceed to request the authenticator context information and/or the service authorization information for remote unit 101 from authenticator ASN 151. Target ASNs 131 and 141 may also proceed with data path establishment signaling with anchor DP ASN 161; however, the target ASNs may instead wait to proceed with data path establishment until handover by the remote unit to one of them is confirmed.

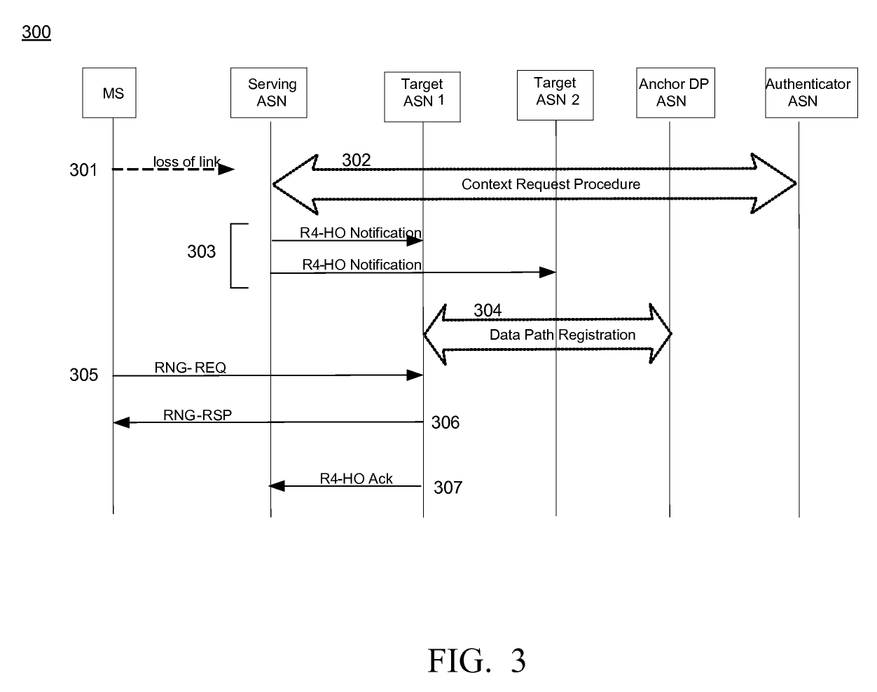

FIG. 3 is a signaling flow diagram 300 that depicts an example of a serving ASN pushing context information obtained from the authenticator ASN to potential target ASNs, in accordance with multiple, yet quite specific, embodiments of the present invention. The following is a detailed description of the signaling flow with reference to the individual signaling instances labeled in FIG. 3:
301. The Serving ASN detects loss of link with the MS.
302. The Serving ASN requests Authenticator context and service authorization information for the MS by sending an R4-Context Request message on the R4 interface to the Authenticator ASN. The Authenticator ASN returns Authenticator context for the MS in the R4-Context Response message to the Serving ASN. Alternatively (although not shown), the Serving ASN may request the Authenticator ASN to push Authenticator context for the MS directly to the Target ASN(s). In this case, the Authenticator ASN sends Authenticator context for the MS to the Target ASN(s) directly.
303. Based on previously reported or deduced target BS information, the Serving ASN sends a message to push Authenticator Context and service authorization information for the MS (or alternatively, the Authenticator ASN ID, which may speed up notification to the Target ASNs but may slow down the handover, since the Target ASN now has to retrieve the AK context from the Authenticator), the Anchor DP ASN ID, latest MAC context information it has for the MS to each Target ASN controlling potential target BSs which the MS may select to handover to. The message includes an indication that the MS may initiate an ‘unsolicited’ handover with the Target ASN(s). The Serving ASN starts a HO notification timer after sending the message.
304. The Target ASN uses the Anchor DP ASN ID provided by the Serving ASN to initiate a data path registration with the Anchor DP ASN for the mobile. The Anchor DP ASN confirms establishment of the data path registration. If an Anchor ASN ID was not provided, the data path function is hosted by the Serving ASN and the Target ASN initiates data path registration with the Serving ASN.
305. The MS performs an unsolicited handover at a target BS controlled by Target ASN1 by performing handover ranging (RNG_REQ message sent). This may occur any time after 301. Target ASN1 uses the Authenticator context to authenticate the MS (via RNG-REQ) message.
306. The Target ASN1 sends a RNG-RSP message to the MS acknowledging the HMAC/CMAC tuple (expedited security authentication) and containing the HO Process Optimization TLV. See e.g., 802.16e-2005 6.3.2.3.6 Ranging Response (RNG-RSP) message, 11.1.2 HMAC/CMAC Tuple, 6.3.22.2.7 Network entry/re-entry, and 11.6 RNG-RSP management message encodings Table 3-67.
307. The Target ASN1 responds with a R4-HO Ack message to notify the Serving ASN that the MS has successfully completed a handover to it. Upon reception of the R4-HO-Ack message, the Serving ASN releases context information for the mobile and stops the HO notification timer.

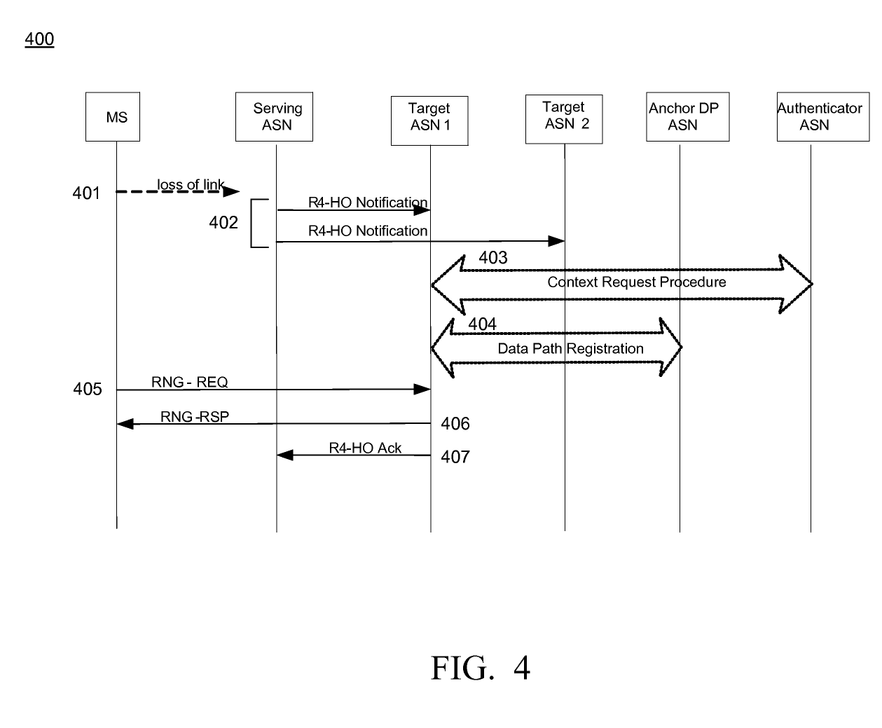

FIG. 4 is a signaling flow diagram (400) that depicts an example of a serving ASN identifying the authenticator ASN from which context information may be obtained by a target ASN, in accordance with multiple, yet quite specific, embodiments of the present invention. The following is a detailed description of the signaling flow with reference to the individual signaling instances labeled in FIG. 4:
401. The Serving ASN detects loss of link with the MS.
402. Based on previously reported or deduced target information, the Serving ASN sends a message to push the Authenticator ASN ID, the Anchor DP ASN ID, and latest MAC context information it has for the MS to each Target ASN controlling potential target BSs which the MS may select to handover to. The message includes an indication that the MS may initiate an ‘unsolicited’ handover with the Target ASN(s). The Serving ASN starts a HO notification timer after sending the message.
403. The Target ASN requests Authenticator context and service authorization information for the MS by sending an R4-Context Request message on the R4 interface to the Authenticator ASN. The Authenticator ASN returns Authenticator context for the MS in the R4-Context Response message to the Target ASN.
404. The Target ASN uses the Anchor ASN ID provided by the Serving ASN to initiate a data path registration with the Anchor DP ASN for the mobile. The Anchor DP ASN confirms establishment of the data path registration. If an Anchor ASN ID was not provided, the data path function is hosted by the Serving ASN and the Target ASN initiates data path registration with the Serving ASN.
405. The MS performs an unsolicited handover at a target BS controlled by Target ASN1 by performing handover ranging (RNG_REQ message sent). This may occur any time after 401.
406. Target ASN1 uses the Authenticator context to authenticate the MS message. The Target ASN1 sends a RNG-RSP message to the MS acknowledging the HMAC/CMAC tuple (expedited security authentication) and containing the HO Process Optimization TLV.
407. The Target ASN1 responds with a R4-HO Ack message to notify the Serving ASN that the MS has successfully completed a handover to it. Upon reception of the R4-HO-Ack message, the Serving ASN releases context information for the mobile and stops the HO notification timer.

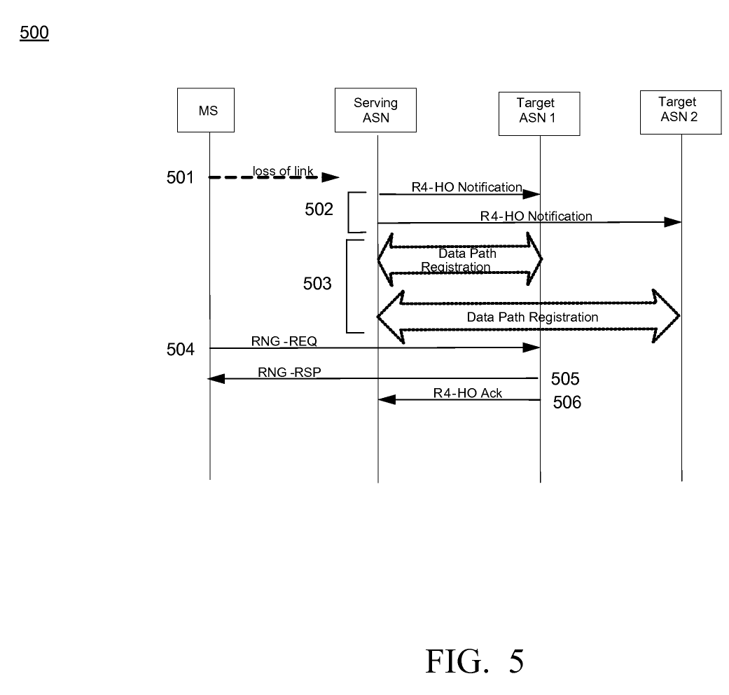

FIG. 5 is a signaling flow diagram that depicts an example of a serving ASN pushing context information to potential target ASNs, in accordance with multiple, yet quite specific, embodiments of the present invention. The following is a detailed description of the signaling flow with reference to the individual signaling instances labeled in FIG. 5:
501. The Serving ASN detects loss of link with the MS.
502. Based on previously reported or deduced Target information, the Serving ASN sends an R4-HO Notification message to push Authenticator Context and service authorization information for the MS, and latest MAC context information it has for the MS to each Target ASN controlling potential target BSs that may be selected by the MS to handover to. The message includes an indication that the MS may initiate ‘unsolicited handover to the Target ASN(s).
503. The Serving ASN initiates data path registration with the Target ASN(s). Alternatively, the Target ASN(s) initiates data path registration with the Serving ASN.
504. The MS performs an unsolicited handover at a target BS controlled by Target ASN1 by performing handover ranging (RNG_REQ message sent). This may occur any time after 501.
505. Target ASN1 uses the Authenticator context to authenticate the MS message. The Target ASN1 sends a RNG-RSP message to the MS acknowledging the HMAC/CMAC tuple (expedited security authentication) and containing the HO Process Optimization TLV.
506. The Target ASN1 responds with a R4-HO Ack message to notify the Serving ASN that the MS has successfully completed a handover to it. Upon reception of the R4-HO-Ack message, the Serving ASN releases context information for the mobile and stops the HO notification timer.

One of skill in the art will appreciate that various modifications and changes may be made to the specific embodiments described above with respect to FIGS. 3-5 without departing from the spirit and scope of the present invention. Thus, the discussion of certain embodiments in greater detail above is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) are intended to encompass all the various techniques available for communicating or referencing the object being indicated. Some, but not all examples of techniques available for communicating or referencing the object being indicated include the conveyance of the object being indicated, the conveyance of an identifier of the object being indicated, the conveyance of information used to generate the object being indicated, the conveyance of some part or portion of the object being indicated, the conveyance of some derivation of the object being indicated, and the conveyance of some symbol representing the object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for supporting handover in a communication network comprising:
detecting, by a serving access service network (ASN), a communication loss with a remote unit;
sending, to one of a target ASN and an authenticator ASN, by the serving ASN in response to detecting the communication loss, a message containing at least one of
authenticator context information for the remote unit,
service authorization information for the remote unit,
an authenticator ASN identifier,
an anchor data path (DP) ASN identifier, and
at least one target ASN identifier.

2. The method of claim 1, further comprising
sending messaging, by the serving ASN to the authenticator ASN, in response to detecting the communication loss, regarding at least one of
the authenticator context information for the remote unit and
the service authorization information for the remote unit.

3. The method of claim 2, wherein sending messaging, by the serving ASN to the authenticator ASN, in response to detecting the communication loss comprises
initiating a context request procedure by the serving ASN with the authenticator ASN.

4. The method of claim 2, further comprising
receiving messaging, by the serving ASN from the authenticator ASN, containing at least one of
the authenticator context information for the remote unit and
the service authorization information for the remote unit.

5. The method of claim 1, wherein sending the message in response to detecting the communication loss comprises
sending, to the target ASN by the serving ASN in response to detecting the communication loss, authenticator context information for the remote unit and service authorization information for the remote unit.

6. The method of claim 1, wherein sending the message in response to detecting the communication loss further comprises
sending, to the target ASN by the serving ASN in response to detecting the communication loss, the authenticator ASN identifier and the anchor DP ASN identifier.

7. The method of claim 1, wherein sending the message in response to detecting the communication loss further comprises
sending, to the target ASN by the serving ASN in response to detecting the communication loss, at least one of
MAC (media access control) context information for the remote unit and
an indication that the remote unit may initiate a handover with the target ASN.

8. The method of claim 1, wherein sending the message in response to detecting the communication loss comprises
requesting, by the serving ASN in response to detecting the communication loss, the authenticator ASN to send the target ASN at least one of
the authenticator context information for the remote unit and
the service authorization information for the remote unit.

9. The method of claim 1, further comprising
initiating, by the serving ASN with the target ASN, data path registration for the remote unit.

10. The method of claim 1, further comprising
receiving, by the serving ASN from the target ASN, a message indicating handover completion of the remote unit to the target ASN.

11. A method for supporting handover in a communication network comprising:
receiving, by a target access service network (ASN), an unsolicited handover request from a remote unit;
receiving, by the target ASN from one of a serving ASN and an authenticator ASN, a message containing at least one of
authenticator context information for the remote unit,
service authorization information for the remote unit,
an authenticator ASN identifier, and
an anchor data path (DP) ASN identifier;
wherein the target ASN receives the message without requesting context information for the remote unit.

12. The method of claim 11, further comprising
receiving, by the target ASN at least one of
MAC (media access control) context information for the remote unit and
an indication that the remote unit may initiate a handover with the target ASN.

13. The method of claim 11, further comprising
exchanging, by the target ASN with the serving ASN, signaling to establish data path registration for the remote unit.

14. The method of claim 11, further comprising
exchanging, by the target ASN with the serving ASN, signaling to establish data path registration for the remote unit.

15. The method of claim 11, further comprising
exchanging signaling by the target ASN with an anchor DP ASN to establish data path registration for the remote unit using the anchor DP ASN identifier received.

16. The method of claim 11, further comprising
authenticating, by the target ASN, one of the remote unit and remote unit signaling using the authenticator context information received.

17. The method of claim 11, further comprising
sending, by the target ASN to the serving ASN, a message indicating handover completion of the remote unit to the target ASN.

18. An access service network (ASN) comprising:
a transceiver;
a network interface; and
a processing unit, communicatively coupled to the transceiver and the network interface,
adapted to detect, via the transceiver, a communication loss with a remote unit and
adapted to send, to one of a target ASN and an authenticator ASN, via the network interface and in response to detecting the communication loss, a message containing at least one of,
authenticator context information for the remote unit,
service authorization information for the remote unit,
an authenticator ASN identifier,
an anchor data path (DP) ASN identifier, and
at least one target ASN identifier.

19. An access service network (ASN) comprising:
a transceiver;
a network interface; and
a processing unit, communicatively coupled to the transceiver and the network interface,
adapted to receive, via the transceiver, an unsolicited handover request from a remote unit,
adapted to receive, via the network interface from one of a serving ASN and an authenticator ASN, a message containing at least one of
authenticator context information for the remote unit,
service authorization information for the remote unit,
an authenticator ASN identifier, and
an anchor data path (DP) ASN identifier,
wherein the target ASN receives the message without requesting context information for the remote unit.
